(19) United States
(12) Patent Application Publication
(10) Pub. No.: US 2024/0384849 A1
(43) Pub. Date: Nov. 21, 2024

(54) LIGHT GUIDE WITH SINGLE OPTICAL CAVITY

(71) Applicant: Magna Exteriors Inc., Aurora (CA)

(72) Inventor: Chris Williamson, Macomb, MI (US)

(73) Assignee: Magna Exteriors Inc., Aurora (CA)

(21) Appl. No.: 18/785,891

(22) Filed: Jul. 26, 2024

Related U.S. Application Data
(63) Continuation of application No. PCT/US2023/061423, filed on Jun. 27, 2023.
(60) Provisional application No. 63/304,294, filed on Jan. 28, 2022.

(51) Int. Cl. F21S 41/24; F21S 41/141

(52) U.S. Cl. CPC F21S 41/24; F21S 41/141

(57) ABSTRACT

A lighting device including predetermined harmonious lighting zones with independence utilizing a single cavity. The lighting device provides predetermined selectively independent lighting zones that can have harmonious appearance when turned all on but maintain crisp zone definition when turned on independently. These lighting zones are generated by a single optical cavity. Hexagonal or other predetermined shaped one-piece or multi-piece lens includes inside plating to provide inner and outer light separation. There is provided isolation of light guides by use of plating in a one piece design or multipiece design.

### CROSS-REFERENCE TO RELATED APPLICATIONS

This application is a PCT International Patent Application and claims benefit of U.S. Provisional Patent Application No. 63/304,294, filed Jan. 28, 2022. The disclosures of the above application are incorporated herein by reference.

### FIELD OF THE INVENTION

The present invention relates to lighting including optical zones utilizing a single cavity such as a hex lit liftgate light.

### BACKGROUND OF THE INVENTION

Exterior rear vehicle lighting is well known for signaling, safety, and aesthetics. There is desired an optical design with lighting zones.

The present invention generates independent lighting zones that have a harmonious appearance when all turned on but maintain crisp zone definition when turned on independently. These lighting zones are operably generated by a single optical cavity.

### SUMMARY OF THE INVENTION

The present invention is directed to providing harmonious lighting zones with independence utilizing a single cavity. According to aspects of the present invention, there is provided a hexagonal 1-piece lens with inside plating to provide predetermined inner and outer light separation as desired. One focus of the invention is to include isolation of light guides by use of plating in a one-piece design, which may be, but is not limited to, a generally hexagonal shape. The present invention is also adaptable and provides for a multi-piece design depending on the particular applications. According to various aspects, the present invention is related to predetermined optical designs separating a lit cavity into at least two separate zones and is operably adapted for connecting to vehicles, e.g., to rear body part, bumper, tailgate, liftgate, tail light panel, spoiler, trunk, light bar panel, rocker panel, roof, hood, wheel quarter panel, fender, lamp, and any other vehicle area/part and combinations thereof.

One goal in this invention is to generate independent lighting zones that can selectively have harmonious appearance when all turned on, but maintain crisp zone definition when turned on independently. These lighting zones are operably generated by a single optical cavity.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an exemplary housing guide of a lamp device, in accordance with the present invention;

FIG. 2 is a front elevation view of a lamp device, in accordance with the present invention;

FIG. 3 is a perspective view of an exemplary housing of the lamp device, in accordance with the present invention;

FIG. 4 is a front elevation view of the lamp device with an exemplary center and an exemplary ring illuminated, in accordance with the present invention;

FIG. 5 is a front elevation view of the lamp device with an exemplary ring illuminated, in accordance with the present invention; and

FIG. 6 is a front elevation view of the lamp device with an exemplary center illuminated, in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

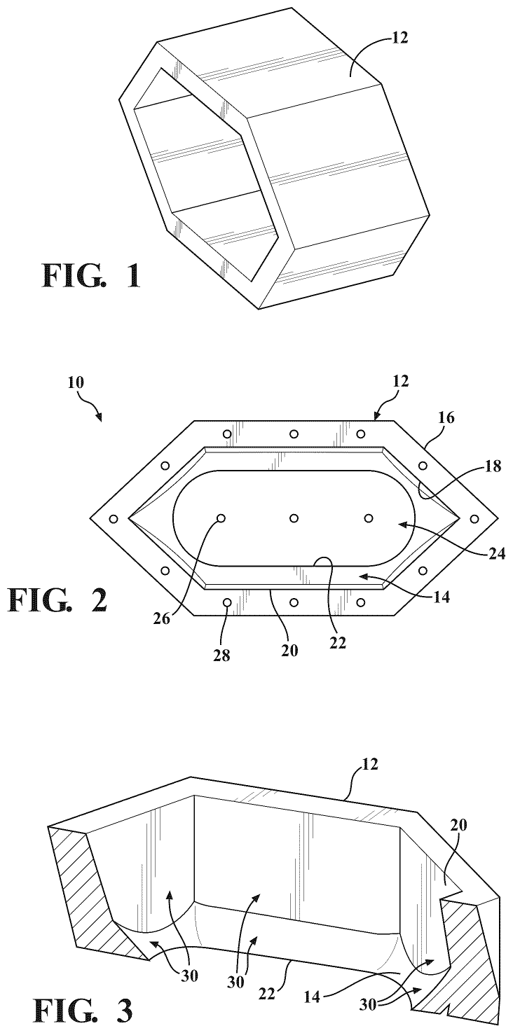

Referring to FIGS. 1-6 generally, there is provided a lamp device assembly shown generally at 10 operable to selectively generate predetermined plurality of independent lighting zones (e.g., and a plurality of predetermined combinations of lighting) that can have a predetermined harmonious appearance when turned on together (e.g., at least one light emitting diode, more preferably, a plurality of LEDs turned on), but maintains crisp zone definition when turned on independently (e.g., on/off central lighting, on/off ring lighting, on/off predetermined directed lighting, on/off additional or alternative suitable lighting, and any combinations). These lighting zones are preferably operably generated by a single optical cavity.

The present invention utilizes a single cavity molded part 10 to operably distribute light into a plurality of zones which offer up harmonious appearance at the surface when: (a) Any single zone is operably illuminated, such as the outer ring 12 or “housing” or “light guide” or “blade”; or, (b) All zones are operably illuminated at the same time, such as at least the outer ring 12 and central zone indicated generally at 24.

This is executed by using a single molded component that allows optical enhancement of light for an outer zone via a light guide, while using the inner cavity to reflect the light to the surface in a controlled manner to distribute the light evenly.

By way of example, using a single molded component (e.g., lamp device 10) that allows optical enhancement of light for an outer zone via light guide 12, while using an inner cavity portion 22 to reflect the light to at least one surface, e.g., outer surface 16, in a controlled manner to distribute the light evenly.

Referring more particularly to FIGS. 2-3 there is depicted an exemplary lamp device 10 including at least one light blade 12 and at least one coated portion 14 (e.g., aluminum coating, reflective coating, metal, painted, reflective coating, etc., most preferably aluminum) that preferably has a predetermined contour. Preferably, this is a single cavity molded part (e.g., the light blade 12 and coated portion 14 are first integrally molded). The light blade 12 (or “guide”) is preferably a clear housing, such as of a clear polycarbonate material. The light blade 12 has an outer surface 16 and inner surface portion 18 forming a generally hexagonal shaped light guide 12. However, it is understood that the present invention is adaptable for any alternative shapes and configurations contemplated depending on the application without departure from the scope of the present invention, e.g., generally oval, circular, rectangular, and any other suitable shape depending on the particular application.

The inner portion 18 and/or the coated portion 14 includes a plurality of reflective surfaces, most preferably, metallic surfaces, indicated generally at 30 in FIG. 3. According to aspects of the present invention, at least some of the reflective surfaces 30 are preferably at a plurality of predetermined angles from vertical to the light guide 12 body (e.g., see FIGS. 2-3). Preferably, reflective surfaces 30 are generally located in the areas spanning from a central surface 22 of the coated area 14 and includes the plurality of central surfaces 20 adjacent the clear light blade 12. In this way, the reflective surfaces 30 coat the central cavity of the light blade 12. Preferably, at least one pair of opposed inner longitudinal sides 20 extend substantially linearly, while having a different predetermined profile along a plurality of inner sides, e.g., curved, angled a predetermined amount from the hexagonal light guide 12 outer shape, etc. In accordance with aspects of the present invention, the present invention utilizes a single molded component 10 that allows optical enhancement of light for an outer zone via light guide 12, while using the inner cavity 14/20/30 to reflect the light to at least one predetermined surface in a controlled manner distributes the light evenly.

At least one light source is provided, e.g., light emitting diode (LED). Preferably, a plurality of LEDs are provided at predetermined locations in lamp device 10. By way of non-limiting example, at least one LED 26 operably mountable in a central portion indicated generally at 24. By way of non-limiting example, a plurality of LEDs 28 in the light blade 12. Or any combination of light guide 12 and central portion 24 light sources.

According to aspects of the present invention, at least one integral reflective surface 30 allows zoned lighting separation. Preferably, a coated inward disposed surface that is continuous without a gap or space in reflective surface coating. It is understood that alternatively, the coated reflective surfaces may be molded or otherwise formed with predetermined material(s) incorporating operable reflective properties.

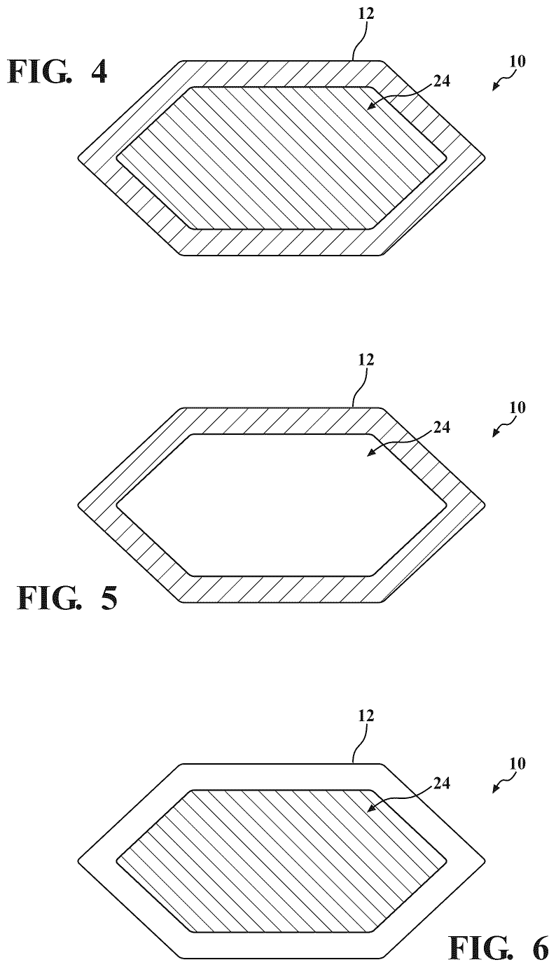

FIGS. 4-6 illustrate exemplary lamp 10 lighting. FIG. 4 depicts the center 24 and ring 12 (guide) illuminated by at least one light source, e.g., LED. FIG. 5 depicts the ring 12 substantially illuminated by at least one light source, e.g., LED. FIG. 6 depicts only the center 24 substantially illuminated by at least one light source, e.g., LED.

According to aspects of the present invention, the light device assembly 10 is turned off/on under at least one of a predetermined condition, e.g., vehicle braking, key fob vicinity, motion or other sensor detected, night lighting, ambient lighting, ride share indication, turn signaling, autonomous signal, or any other suitable predetermined condition, and any combinations thereof.

According to aspects of the present invention the light device assembly 10 is in predetermined operable communication with the vehicle, e.g., wirelessly or hard wired.

It is understood that while a hexagon is illustrated, any predetermined shape is contemplated without departing from the scope of the present invention.

The light device 10 or lamp assembly is operably adapted to connect to any predetermined part, such as but not limited to, a liftgate of a motor vehicle. In accordance with aspects of the present invention, at least one lamp device 10 is operably adapted to connect to or be operably integrated into an appliance, electric compliance, automotive component, mobile device, computing device, windowpane, automotive glass, rear window, windshield, touch screen display, heads-up touchscreen display, instrument panel, instrument cluster, bezel, and any combinations thereof.

At least one light device 10 or lamp assembly is operably adapted to connect to any predetermined vehicle part for at least one predetermined function, e.g., such as but not limited to brake lighting, caution lighting, headlamp, predetermined vehicle and/or ground illumination under predetermined conditions, integrated messaging, etc.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A lamp device adapted for a vehicle, comprising:
at least one lighting source;
at least one light guide; and
a single molded component that allows optical enhancement of light from said lighting source for an outer zone of said lamp device via said at least one light guide, while using an inner cavity of said lamp device to reflect the light to at least one surface of the lamp device in a predetermined controlled manner to distribute the light evenly.

2. The lamp device of claim 1, wherein said light guide includes at least one coated portion.

3. The lamp device of claim 2, wherein said at least one coated portion includes a plurality of central metalized surfaces.

4. The lamp device of claim 1, wherein said at least one light guide is formed of a clear material.

5. The lamp device of claim 1, wherein the at least one light guide is a clear polycarbonate material.

6. The lamp device of claim 1, wherein the lamp device is a 1-piece hexagonal lens with inside reflective plating to provide inner and outer light separation.

7. The lamp device of claim 1, wherein the lamp device includes isolation of the at least one light guide by use of plating in a one-piece design.

8. The lamp device of claim 1, wherein the lamp device includes a multi-piece lens with inside plating operable to provide inner and outer light separations.

9. The lamp device of claim 1, wherein the lamp device is operably adapted to connect to a rear part of a motor vehicle. 10 The lamp device of claim 1, wherein at least one lamp device is operably adapted to connect to or be integrated into an appliance, electric compliance, automotive component, mobile device, computing device, windowpane, automotive glass, rear window, windshield, touch screen display, heads-up touchscreen display, instrument panel, instrument cluster, bezel, and any combinations thereof.

11. The lamp device of claim 1, further comprising a plurality of reflective surfaces operable to allow selective lighting zone separation.

12. The lamp device of claim 11, wherein said plurality of reflective surfaces comprise a continuous coated central surface having at least one predetermined profile operable to direct light in at least one predetermined direction.

13. The lamp device of claim 1, including at least one pair of opposing longitudinal reflective surfaces, and a plurality of adjacent integral reflective surfaces having at least one other predetermined profile.

14. The lamp device of claim 1, wherein said at least one lighting source comprises at least one light emitting diode operably mounted at a central portion of said light guide, and at least one light emitting diode operably mounted to said at least one light guide.

15. The lamp device of claim 1, wherein lamp device illumination is automatically determined under predetermined conditions, wherein selective lighting is provided to illuminate said light guide or illumination of a central portion of said lamp device or said light guide and central portion simultaneously.

16. A lamp device adapted for a vehicle, comprising:
at least one lighting source;
at least one single cavity molded part with at least one single optic cavity, said single cavity molded part operable to distribute light into zones which selectively provides predetermined harmonious appearance at the surface when any single zone is illuminated and when all zones are illuminated at the same time.

17. A lamp device adapted for connecting to a vehicle, comprising:
at least one lighting source; and
at least one light guide with inside plating to provide inner and outer light zone separation, wherein said separation includes operably generating independent lighting zones comprising at least said inner and outer zones that selectively allow substantially harmonious appearance when operably turned on together but maintain crisp zone definition when operably turned on independently.

18. The lamp device of claim 17, further comprising a plurality of reflective surfaces operable to allow selective lighting zone separation.

19. The lamp device of claim 17, wherein said plurality of reflective surfaces comprise a continuous coated central surface having at least one predetermined profile operable to direct light in at least one predetermined direction.

20. The lamp device of claim 17, wherein said at least one lighting source comprises a plurality of light emitting diodes operably mounted in said inner zone, and a plurality of light emitting diodes operably mounted at said outer zone.
